(19) United States
(12) Patent Application Publication
(10) Pub. No.: US 2004/0003084 A1
(43) Pub. Date: Jan. 1, 2004

(54) Network resource management system

(76) Inventors: Dale W. Malik, Dunwoody, GA (US); Lee G. Friedman, Alpharetta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/211,053

(22) Filed: Aug. 1, 2002

Related U.S. Application Data
(60) Provisional application No. 60/382,106, filed on May 21, 2002.

(51) Int. Cl. H04L 9/00; G06F 15/16

(52) U.S. Cl. 709/225; 713/201; 709/204

(57) ABSTRACT

Network resource management systems are provided. A representative network resource management system includes a server operable to provide a remote terminal coupled to the network with a class of service marker specific to a user of the remote terminal, and a roster list comprising a plurality of resources present on the network. The server is also operable to receive a routing request from the remote terminal, the routing request comprising a request for at least one resource from the roster list and the class of service marker. The server being operable to check the class of service marker of the remote terminal before permitting access to the resource by the user. Methods and other systems for network resource management are also provided.

### CROSS-REFERENCE TO RELATED APPLICATION

This application claims priority to copending U.S. provisional application entitled, “INTEGRATION OF INSTANT MESSAGING AND COMPUTER OPERATING SYSTEMS,” having ser. No. 60/382,106, filed May 21, 2002, which is entirely incorporated herein by reference.

### FIELD OF THE INVENTION

The present invention is generally related to telecommunications and more particularly to management of network resources.

### DESCRIPTION OF THE RELATED ART

The development of the internet has driven vast technological developments, particularly in the areas of networking hardware and software. Networking hardware developments have enabled networks to transfer large files in fractions of a second. Software developments, such as the world-wide-web (web) and e-mail, have facilitated communications over these networks that have allowed users to remain in almost constant contact with work. These types of communications have become of utmost importance in the business setting, where response time has become a key survival factor for many companies. Other networking software has allowed users to access and run applications from remote locations, thus enabling a businessperson to remain more productive, even on a business trip.

Moreover, the internet has changed the way people communicate. E-mail has become the dominant means of communications in many settings, being preferred over traditional mail, and even telephones in some cases. Almost instantaneous communication with little charge has driven much of the popularity of e-mail. Once used only in university and military settings, e-mail has gained widespread public acceptance.

In a world economy based largely upon communication, the relative speed of e-mail in comparison to traditional mail is often not fast enough or as effective. Demand for faster access to more information has resulted in the development of a number of instant messaging (IM) services. IM brings presence information into the communications arena, and it allows users to have real-time chat sessions with other users who are present on the system. The real-time nature of IM has led to quick acceptance by many in the business community of IM as an invaluable tool for communication. However, current IM systems have administration and management problems.

Therefore, there is a need for systems and method that address these and/or other perceived shortcomings of the prior art.

### SUMMARY OF THE INVENTION

One embodiment, among others, of the present invention provides systems and methods for network resource management. A representative system includes a server on a network operable to provide a remote terminal coupled to the network with a class of service marker specific to a user of the remote terminal, and a roster list comprising a plurality of resources present on the network. The server is further operable to receive a routing request from the remote terminal, the routing request comprising a request for at least one resource from the roster list and the class of service marker. The server is even further operable to check the class of service marker of the remote terminal to verify authorization before providing access to the resource by the user.

A method, among others, for managing access to network resources includes: receiving a registration request over a network from a user of a remote terminal; searching a database to find a class of service marker associated with the user; and sending the class of service marker to the remote terminal with a roster list comprising a plurality of resources which are present.

Another method, among others, for requesting use of a resource includes: registering with a server residing on a network; receiving a class of service marker and a roster list corresponding to a plurality of resources which are present on the network; requesting a resource from the roster list; and including the class of service marker with the resource request.

Other systems, methods, features, and advantages of the present invention will be or become apparent to one with skill in the art upon examination of the following drawings and detailed description. It is intended that all such additional systems, methods, features, and advantages included within this description and be within the scope of the present invention.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1A is a block diagram illustrating an interoperability architecture for instant messaging used in one embodiment, among others, of the present invention.

FIG. 1B is a block diagram illustrating an alternative embodiment, among others of an interoperability architecture for instant messaging used in one embodiment, among others, of the present invention.

FIG. 2 is a block diagram of the interoperability architecture used in one embodiment, among others, of the present invention.

FIG. 3 is a block diagram of a network resource management system in one embodiment, among others, of the present invention.

FIG. 4 is a flowchart illustrating one embodiment of the operation of the network resource management system of FIG. 3.

FIG. 5 is a flowchart illustrating one embodiment of the operation of the client of FIG. 3.

### DETAILED DESCRIPTION OF THE PREFERRED EMBODIMENTS

The preferred embodiments of the present invention now will be described more fully with reference to the accompanying drawings. The invention may, however, be embodied in many different forms and should not be construed as limited to the embodiments set forth herein; rather, these embodiments are intended to convey the scope of the invention to those skilled in the art. Furthermore, all “examples” given herein are intended to be non-limiting.

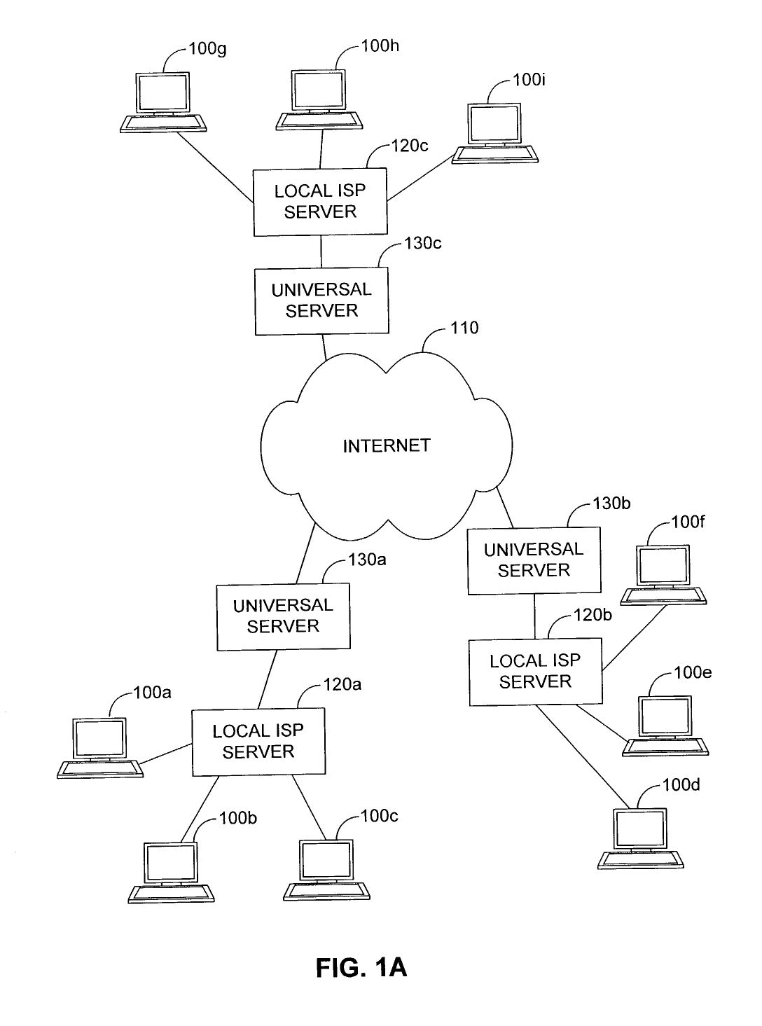

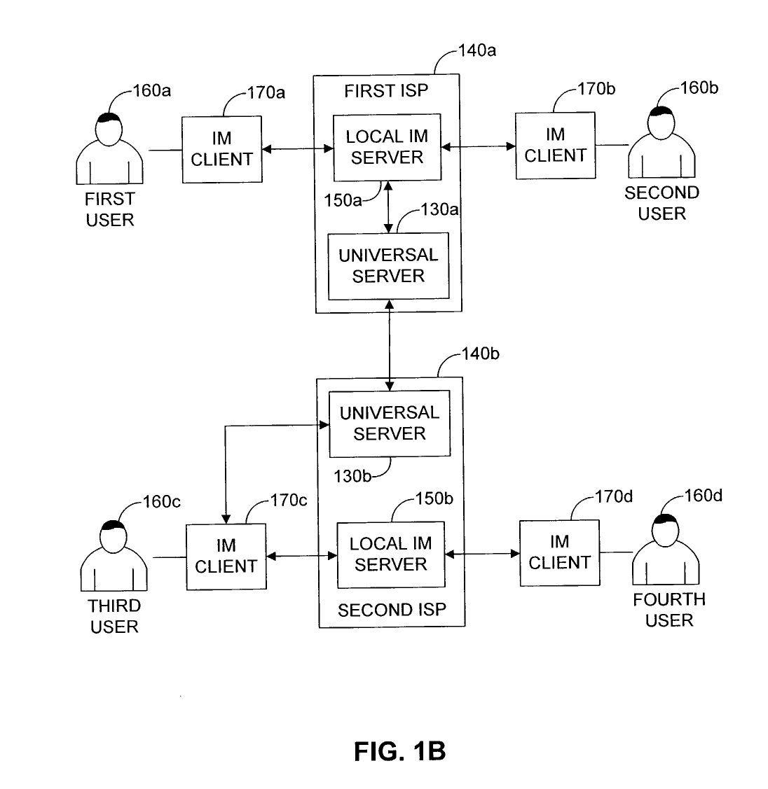

Referring now to FIG. 1A, shown is a block diagram illustrating an interoperability architecture for instant messaging used in one embodiment, among others, of the present invention. Each of a plurality of remote clients 100a-i access a network 110 through a local internet service provider (ISP) server 120a-c. The local ISP 120a-c can offer network 110 access through a plethora of connection types, including a digital subscriber line (DSL) service, an integrated services digital network (ISDN) service, an analog dial-up service, ethernet, T-1, or any other service for transmitting data through a network 110. Universal servers 130a-c are located between the internet and each of the local ISP servers 120a-c. These universal servers 130a-c provide interoperability between a plurality of proprietary instant messaging clients 100a-i.

Referring now to FIG. 1B, shown is an illustration of an alternative embodiment, among others, of a universal architecture. Greater detail regarding this interoperability architecture may be found in U.S. patent application Ser. No. 10/135,929, entitled “Instant Messaging Architecture and System for Interoperability and Presence Management,” which is hereby incorporated by reference. The universal architecture uses a universal protocol, such as the extensible markup language (XML) protocol to allow users of different ISPs 140a, 140b that use proprietary protocols to communicate with one another. Universal servers 130a, 130b located at each of the ISPs 140a, 140b are the key feature of the universal architecture. FIG. 1B illustrates two separate ISP networks 140a, 140b. Because the two networks are identical, the discussion of the universal architecture for purposes of this application is limited to the ISP 140a, 140b. Additionally, the discussion of the ISP 140a, 140b will be limited to the components that provide the universal service.

The ISP 140a contains two servers: a local IM server 150a and the universal server 130a. The local IM server 150a provides the standard IM function for the ISP 140a. The universal server 130a provides the universal function that allows the first user 160a, who is registered with the first ISP 140a, to communicate with a second user 160b registered with the second ISP 140b. The first ISP 140a provides connections to a plurality of clients 170a, 170b, which allows users 160a, 160b to access the proprietary IM and universal functions of the ISP 140a. The first ISP 140a is “bimodal,” in that it uses both a proprietary and universal format to provide a proprietary IM function that only allows the users who are registered with the ISP 140a to send and receive instant messages. For example, if only one user has registered with the universal server 130a, then the local IM server 150a will transfer instant messages between the first and second users 160a, 160b using the proprietary protocol. However, if both the first and second users 160a, 160b are registered with the universal server 130a, then the first ISP 140a can transfer instant messages between them using the universal protocol. By supporting both formats at the first ISP 140a, users can migrate to the universal format over time. When all users 160a. 160b have migrated the proprietary format can be discontinued.

The universal server 130a removes the restrictions associated with proprietary IM functions associated with the ISP 140a. The universal server 130a uses a universal format, such as XML, or any other suitable format, that allows users 160a, 160b registered with an ISP 140a, such as BellSouth DotNet, to send and receive instant messages from other users 160c, 160d registered with another ISP 140b, such as America Online (AOL).

The user 160a accesses the local IM server 150a of the ISP 140a through the IM client 170a. The IM client 170a typically includes a proprietary software program that is capable of opening communications sockets that allow the IM client to communicate with the local IM server 150a using either the proprietary or universal protocols. The software program is capable of formatting an instant message sent from the IM client 170a to the appropriate format used by the IM function of the ISP 140a. In this manner, the user 170a is capable of communicating with any other user 160b registered with the ISP 140a. However, the local IM server 150a on a first ISP 140a is also connected to a first universal server 130a. The first universal server 130a is in turn, connected to a second universal server 130b on the second ISP 140b via a distributed network, such as the internet. This allows the user 160a to communicate not only with the user 160b who is registered with the first ISP 140a, but also with users 160c who are registered with the second ISP 140b that uses a different proprietary IM protocol to send and receive instant messages within the network of the second ISP 140b.

In order for the first user 160a to be able to send and receive messages with a third user 160c on the second ISP 140b, the IM client 170a must be able to identify the IP address and presence information associated with the third user 160c. The presence information for the third user 160c is stored on the universal server 130a connected to the first ISP 140a. The universal server 130a on the first ISP 140a stores the IP address and presence information for the third user 160c. Therefore, the first user 160a, who is registered with the universal server 130a on the first ISP 140a has access to the IP address and presence information of the third user 160c. The first user 160a will not be able to communicate with a fourth user 160d if the fourth user 160d is not registered with the universal server 130b, but instead is only registered with a local IM server 150b, and as a result, is able to send and receive instant messages using only the proprietary format. Therefore, the user 160d is limited to communicating via instant messages with users of the second ISP 140b, such as the third user 160c.

An advantageous feature of the universal architecture is that it is designed to be easily integrated within existing ISPs 140a, 140b, such as AOL and Microsoft Network (MSN) without disrupting the current IM function of these ISPs 140a, 140b. Each ISP 140a, 140b that adopts the universal architecture requires only a slight modification to the existing network. The ISP 140a, 140b adds an additional server to function as the universal server 130a, 130b and can install a universal application program on the local IM server 150a, 150b and each IM client 170a-d attached to the network. The universal application program that is installed at each IM client 170a-d converts the IM client 170a-d to function as “bimodal.” That is, the IM client 170a-d is capable of using the proprietary IM protocol of the ISP 140a, 140b and the universal protocol of the universal architecture. The bimodal nature of the IM client 170a-d allows the universal server 130a, 130b to be implemented into existing ISPs 140a, 140b such as AOL and MSN without disrupting the current proprietary IM functions of those services. This allows the current users 160a-d to continue using the proprietary IM function of their particular ISP 140a, 140b until every user 160a-d can be converted to the universal protocol.

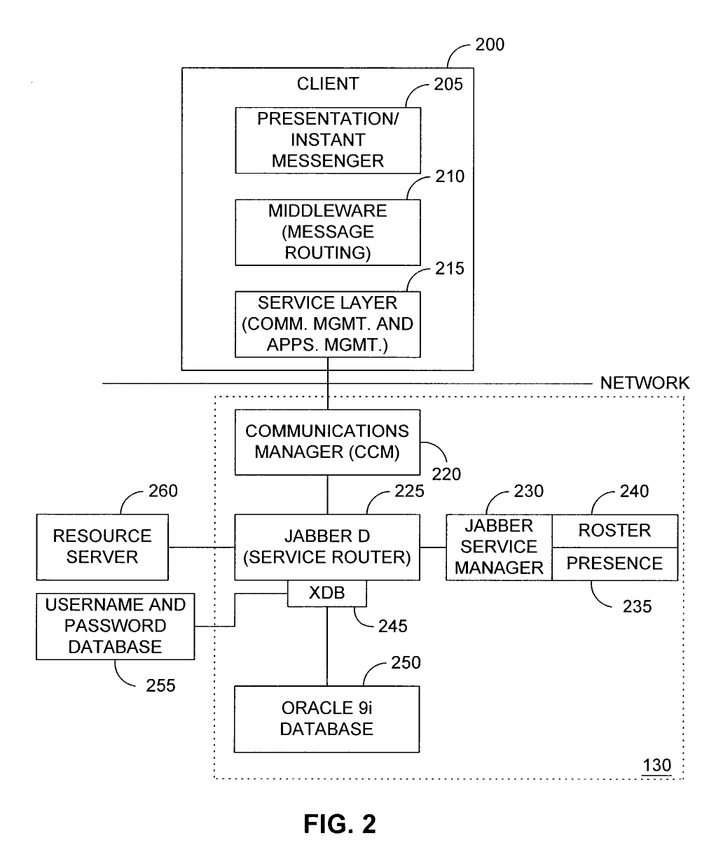

Referring now to FIG. 2, shown is a block diagram illustrating an embodiment, among others, of the universal server 130 of FIGS. 1A & B, which is used in conjunction with an embodiment, among others, of the present invention. The client 200 includes at least three layers of functionality in one embodiment, among others, to communicate with the universal server 130. The first layer is the presentation layer 205. The presentation layer 205 includes the logic that is used to present the instant messenger or another application to a user. The second layer is a middleware layer 210. The middleware layer 210 includes logic used to handle the message routing of the instant messaging application between the presentation layer and the service layer. The third layer is the service layer 215. The service layer 215 handles both the applications management and communications management of the client. The service layer 215 communicates with the communications layer 220 on the universal server 130.

Preferably, there are three basic layers to the instant messaging service. The first layer is the communications manager (CCM) 220. The communications manager 220 manages the connections between the client communications manager 215 and the universal server 130. In one embodiment, among others, of the universal server 130, communications between the client service layer 215 and the universal server 130 communications manager 220 occur in extensible markup language (XML). Further, the communications may be secure socket layer (SSL) encrypted for security. Moreover, the communications can be compressed by a compression/decompression algorithm implemented on a compression-decompression module, more commonly referred to as a CODEC, to provide faster data transfer.

The communications manager 220 includes a number of connection sockets between the communications manager 220 and a plurality of users. The communications manager 220 can further include a load balancer (not shown) to balance the connections over a number of different communications managers. The load balancer can maintain a connection to the same connection socket during the period while the user is logged on and connected to an operable communications manager 220, and can automatically connect the user to an alternate connection socket when a communications manager might fail. Thus, a continuous connection can be maintained during an active session despite hardware failures. The load balancer can also protect the server against denial of service attacks, which have become increasingly prevalent on the internet.

A standard communications manager 220 will typically attempt to recover and reallocate a connection socket after a period of time with no activity from the client 200. In this situation the communications manager 220 assumes that the client is no longer present on the system. However, because presence is an important piece of the instant messaging architecture, the communications layer 215 on the client-side sends a signal to the universal server 130 to keep the connection socket active on the communications manager 220.

The second layer is the service router 225, with one example known as a JabberD in the Jabber architecture, such as that available from Jabber, Inc., of Denver, Colo., which performs a similar function to the message router 210 on the client side of the network. A number of different service managers 230 can be coupled to the service router 225, each of which can provide a different service to the client 200 over the internet. Thus when a service is requested, the service router 225 routes the request to the requested service manager 230. In the instant messaging architecture the service manager 230 is a Jabber service manager (JSM) which allows text communication between parties. The JSM 230 also keeps track of presence and roster information 235, 240, respectively, for a particular user on the network who has logged into the instant messaging system. Presence 235 typically refers to the user's status on the network, while roster 240 typically refers to the status on the network of those on the user's resource list.

Similarly to the communications manager 220, the service router 225 can utilize a self-similar architecture using the CODEC (not shown) and load balancer (not shown) to optimize the connection between the communications manager 220 and the service router 225. Use of the CODEC enables high speed data transmission between the communications manager 220 and the service router 225. The load balancer provides a robustness that allows the client to maintain contact with a selected service manager 230 during a session.

In one embodiment, among others, of the universal server 130, the database containing the non-persistent data, such as presence and roster information 235, 240, can be severed from the service manager 230. The presence information 235 typically includes a list of all users who are registered with the universal server 130, while the roster list includes a non-persistent list of those resource which are present on the network. Thus, the non-persistent data can be maintained and updated at a single database, and the plurality of service routers 225 can connect to the same presence information 235. After severing this database from the service manager 230 the service manager 230 can be equipped, as described above, with a CODEC (not shown) and load balancer (not shown), again utilizing a self-similar architecture to provide quality of service and communication efficiencies.

The service router 225 is further coupled, in one embodiment, among others, to an XML database (XDB) library 245. The XDB library 245 is used as a translator such that the service router 225 can communicate with a database layer 250 that includes persistent data relating to a plurality of clients. The database layer 250 which contains most of the persistent data for the services on the network, such as resource lists, preferences, etc. In one embodiment, among others, of the universal server 130 the database layer 250 can be an Oracle 9i database. The XDB library 245 can be further coupled to an authentication server, such as a username and password database 255. Thus a username and password can be required before the user is authenticated and allowed to access the database layer 250 for any profile information.

After registering with the database layer 250, the user is provided with a resource list. The client 200 can then contact the service manager 230 to find out which of the users on the resource list is present and/or available on the network. Typically, presence refers to the registration state of a client 200. If a client 200 is logged-in to the network, the client 200 is present on the network. Typically, availability refers to the status of a user at the client computer. A user can be made unavailable by the network if there has been no activity on the client computer 200 for a period of time. Otherwise, a client 200 can be made unavailable by user choice, if the user does not wish to be disturbed. One skilled in the art will recognize that these are merely definitions of various states that can be defined according to any specific implementation of the presence and roster databases 235, 240. Furthermore, these databases 235, 240 that contain non-persistent information could keep track of any other states that might be defined by the specific implementation of the service manager 230.

Typically with respect to instant messaging systems, the resource list only comprises a list of other users for which the client 200 wishes to know the status. However, the resource list could include access to a plurality of applications, and there could be multiple service managers which include managers for the plurality of applications coupled to the service router 225. These service managers could provide access to a multitude of different applications and resources, such as Microsoft Word and/or Visio, provided by Microsoft Corp. of Redmond, Wash., and/or billing entry applications, etc. Moreover, the Jabber service manager 230 could keep track of the presence of these other applications and resources on the network. For example, if a client wished to access an e-mail account from a remote location and the system was down, the Jabber service manager 230 could alert the user that the server was down. Thus the client 200 would not waste resources searching and waiting for e-mail from a server that is off-line.

Thus, Jabber can be used similarly to an operating system. When a resource server 260 is present on the network, the resource(s) associated with that resource server can be displayed as an icon on the client computer display, and when a resource server is down, the resource(s) can be removed from the client computer 200 display. Thus, icons, for example, could appear and disappear from a client computer 200 display as they become present and available, and not present or unavailable. Selecting the icon while it is displayed will cause a routing request to be sent to the service router 225. Upon receiving the routing request, the service router 225 will determine the correct routing of the routing request and deliver the proper service to the client computer 200.

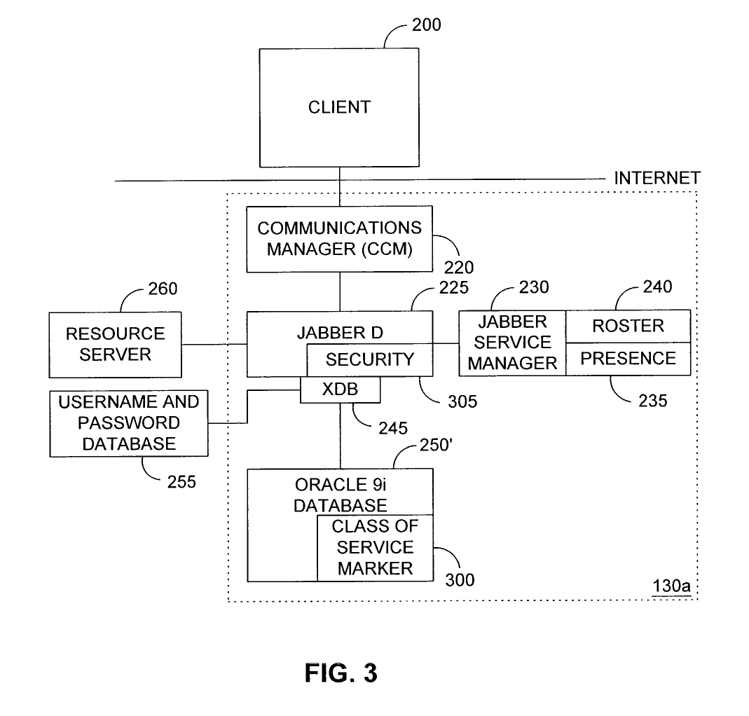

Referring now to FIG. 3, in accordance with one aspect of the present invention, a network administrator may wish to limit access to a network resource. Access could be limited for a number of reasons, including scarcity of a particular resource such as licenses or bandwidth, non-payment of a debt, security, time limits, device location, internet protocol (IP) address, etc. In an embodiment of the universal server 130, (or, in other embodiments, any server controlling resources for users) a class of service marker 300 can be included in a user profile and, preferably, used in conjunction with the presence information to either provide or deny access to any of a plurality of resources on a resource server 260. In various embodiments the plurality of resources could include other users, applications, service managers, connection sockets, or any other resource to which the network administrator might wish to limit access for whatever reason. Definitions of resources available for each class of service marker are also stored and referenced.

The class of service marker 300 is typically stored along with the persistent data in the database layer 250′ of the universal server. In one embodiment, among others, the database layer 250′ includes a class of service marker 300 in the packets sent to the client 200 upon receiving registration and authentication of the user. These packets, which are sent to the client 200 upon registration and authentication, also typically include the resource list information, including contacts and contact groups set up by the user, and references to resources available to the user.

Upon receiving the resource list, the client 200 can send the service manager 230 a request for presence and roster information 235, 240 from the non-persistent database. This request can include the class of service marker in one embodiment, among others, of the present invention, as well as the user's resource list, in some embodiments. The roster information 240 typically includes information about the presence and availability status of the resources on the user's resource list. Therefore each of the resources included on the client computer 200 display can further include information about the status of the resource. Typically, this information can be included by shading the icons corresponding to the status of the resource. A green icon can typically mean that the resource is present and available. A yellow icon can typically mean that the resource is present, but unavailable. A gray icon can typically mean that the resource is not present on the network. One skilled in the art will recognize that these states may be varied and that there exists myriad ways to display the status of the resource to the user on the client computer display, each of which is intended to be included within the scope of this invention.

The class of service marker 300 adds another layer to the presence schema, such that a resource, although the resource server 260 is physically present on the network, can appear not to be present to a particular user with an inadequate class of service marker 300. Thus, in one embodiment, among others, when the service manager 230 receives a request for status information from a client 200, the service manager 230 can also check the class of service marker 300. The service manager 230 can then update the status of those resources to which the user has access, while displaying as not present those resources to which the user's class of service marker 300 is inadequate. In some embodiments, resources for which the class of service marker is inadequate are not displayed at all, or in some embodiments, allowed to be on a user's resource list.

In an alternative embodiment, among others, a security layer 305 can be included within the service router 225. Any requests for a resource (including those possibly not on a user's resource list) would be accompanied by the class of service marker 300 associated with the user. The security layer 305 of the service router 225 would check the class of service marker provided by the user against the class of service marker 300 stored in the persistent database 250. If the class of service marker provided did not match the stored class of service marker 300, the user could be flagged and/or referred to the network administrator. In an alternative embodiment, among others, the request for a resource could be checked against the user's profile to ensure that the profile includes the resource. The universal server 130 could then deny the request if the resource is not in the user's resource list. These checks could provide an extra level of security to ensure that a user has not set up a program to provide a dummy class of service marker, in place of the user's real class of service marker 300, in hopes of gaining unauthorized access to the network resources.

If the class of service marker provided by the user matched the class of service marker stored in the persistent database 250, the security layer 305 of the service router 225 would then check the class of service marker 300 against a rule. If the rule was satisfied by the user's class of service marker 300, the request would be routed. However, if the rule was not satisfied by the class of service marker 300, the service router 225 would refuse the resource request.

In a further alternative embodiment, among others, the service router 225 could be programmed to provide a prompt to the client 200 upon receiving an inadequate class of service marker 300. The prompt could include asking the user whether they would like to upgrade their class of service marker 300, or merely ask them if they would like to pay for the resource per use. If an affirmative answer is given, the service router 225 could record the transaction in the persistent database 250′ or a separate billing database, and route the resource request.

In an alternative embodiment, among others, a security mechanism may be provided whereby upon checking a class of service marker 300 out of the persistent database 250, the class of service marker 300 may be issued with a security string attached. This security string can provide authentication to the universal server 130 when provided with the class of service marker 300. The security string can change day-to-day, or can change every time the user logs onto the universal server 130. Such a security string could be generated from a pretty good privacy (PGP) system wherein the universal system could use a public key to encrypt a password, and retain the private key, such that the password cannot be decrypted by a user and spoofed with another class of service marker 300 using the public key.

One skilled in the art will recognize that the class of service marker 300 can be assigned to network users by a network administrator. Further, the network administrator can assign a class of service marker 300 based upon a number of different objectives. One objective may be pecuniary gain, where the network may be used to achieve subscriptions to various resources provided by the resource server 260.

Another objective may be security of the network. Here, employees could be provided with a class of service marker 300 based upon their approved level of access. Thus, for example, a salesperson would have access to different resources than an engineer. Moreover, the class of service marker 300 could be made dependent upon time of access or location from which access is requested. Therefore, a user may have access to network resources during business hours, but be denied access to these same network resources outside of business hours. Alternatively, the user could be allowed to access the network only from company computers or a particular local network, as determined by an internet protocol and/or media access control (MAC) address provided to the universal server 130 for communications.

These device, location and time based dependencies can be stored in the persistent database 250, the persistent database 250′ providing a class of service marker 300 to the client which is related to any or all of these dependencies. As such, a user could receive a sort of dynamic class of service marker 300 that differs when the user logged in at different times, locations or devices. Alternatively, these dependencies may be built-in to the rule associated with the class of service marker 300, as executed by the security layer 305 or service router 225.

As a further security measure, in an alternative embodiment, among others, the network administrator can invoke a change of presence on a resource server 260 based upon the class of service marker 300. Therefore, if a network administrator suspects that a user has gained unauthorized access to a resource server 260, the network administrator can temporarily force the presence of that resource server 260 off-line. However, this off-line status can be applied to specific class of service marker 300 level(s), such that the resource server will appear off-line to some users, while remaining on-line for other users.

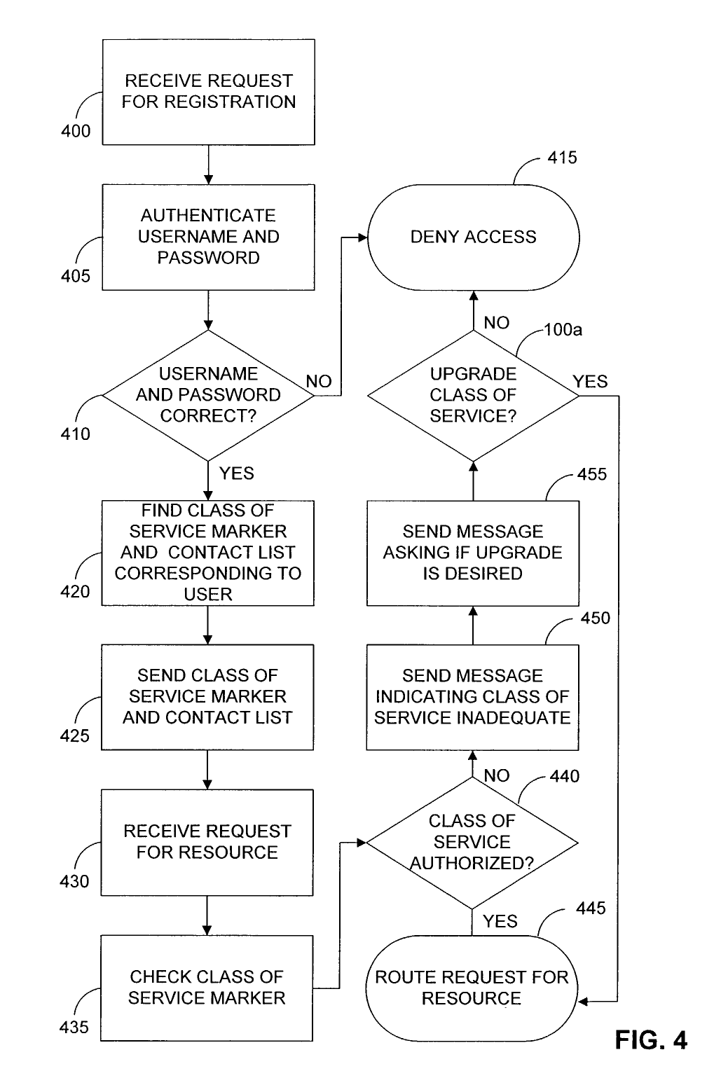

Referring now to FIG. 4, shown is a flowchart illustrating operation of the universal server of FIG. 3. In the first step 400, the universal server 130 receives a registration request. This step may be performed automatically on startup, or after starting the Jabber application. The universal server 130, in the second step 405, will then ask for a username and password to authenticate the user. Typically the username will be a user's Jabber ID (JID), which can correspond to the user's e-mail address, and the password can be chosen by the user. After comparing the username and password received to its username and password database, the universal server 130 will either deny access, according to step 415, or will register the user and find a class of service marker 300 and resource list corresponding to the particular authenticated user, inn accordance with step 420. In the next step 425, the universal server 130 sends the class of service marker 300 and resource list to the client 200. Once the client 200 has received the class of service marker 300 and resource list, the resource list can be displayed on the client computer 200 display.

In alternative embodiments, the client 200 can poll the Jabber service manager 230 to find out which of the resources on the user's resource list are present and available. The Jabber service manager 230 can further be configured to receive the class of service marker 300 from the client 200 and update the resource list displayed on the client computer 200 display according to which resources on the resource list are accessible to the client 200 according to the class of service marker 300.

In the next step 430, the universal server 130 receives a request from the client 200 for a resource to be routed to the client 200. The request is accompanied by a class of service marker 300, and the universal server 130 checks the class of service marker 300, at step 435, to ensure that the class of service is adequate to access the resource. At step 440, if the class of service marker 300 is authorized to access the requested resource, the resource is routed to the client, 445.

If the class of service is not authorized to access the resource a message can be sent to the client 200 indicating that the class of service marker 300 received is inadequate to access the requested resource, according to step 450. In alternative embodiments, this step 450 could be a termination for the exchange, however, in this particular embodiment the universal server 130 sends a message, in accordance with step 455, asking if the user would like to upgrade the class of service, for example, by paying extra money. In the next step 460, the universal server 130 receives an answer from the user. If the user agrees to upgrade their class of service, the client 200 receives a new class of service marker 300 and the service is routed to the client 200, in accordance with step 445. However, if the client 200 does not choose to upgrade the class of service, the client 200 is simply denied access to the resource, according to step 415. In this embodiment, the class of service marker 300 is used as a subscription level, however, in other embodiments the class of service marker 300 may be used as a security mechanism, which cannot be upgraded merely according to the user's desire.

Moreover, in other alternative embodiments the resource server 260 has the option of checking the persistent database 250′ to assure that the class of service marker 300 of the user matches the class of service marker 300 that was received from the client computer 200. This works as a security mechanism to help prevent a user from requesting the class of service marker 300 and then altering the class of service marker 300 to indicate that the client 200 has access to all network resources. In this way, each resource server 260 can be set up to double check the class of service marker to provide extra security.

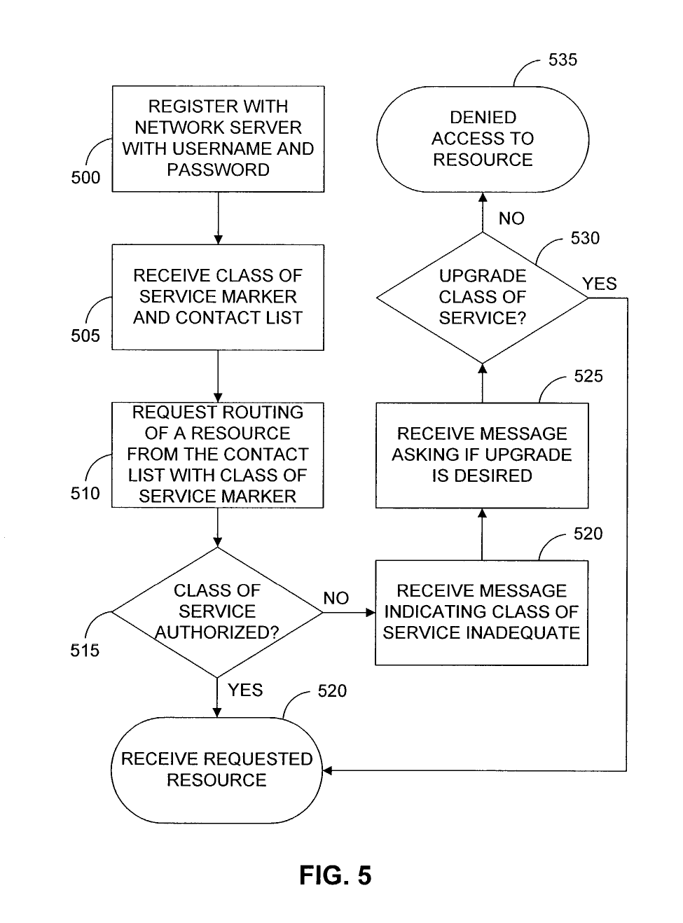

Referring now to FIG. 5, shown is a flowchart illustrating the operation of the client computer 200. In the first step 500, the client 200 registers with the universal server 130 by providing a username and password. Once the client 200 has provided a correct username and password, the next step 505 has the client 200 receiving a resource list from the universal server 130. The resource list can include an updated status on each of the resources included in the resource list. However, in alternative embodiments the client 200 uses the resource list to request status from the Jabber service manager 230. The status request can include the class of service marker 300 assigned to the client 200, such that the Jabber service manager 230 can provide correct status for those applications not accessible to the class of service to which the user belongs, even though they may be present and available.

In the next step 510, the client 200 requests routing of a resource to the client computer 200, including the class of service marker 300 with the routing request. The universal server 130 will receive the routing request and examiner the class of service marker 300 against a policy to ensure that the class of service marker 300 is adequate before routing the requested resource. If the class of service marker 300 is authorized, in the next step 515 the client 200 will receive routing of the requested resource.

If the class of service marker 300 is inadequate to route the resource, in the next step 520 the client 200 will receive a message indicating that the requested resource cannot be routed due to an inadequate class of service marker 300. The client 200 may then receive a prompt querying the user to upgrade the user's class of service, in accordance with the next step 525. The user may then choose to either upgrade the class of service marker 300 or not in the next step 530. If the class of service marker 300 is upgraded, the requested resource is routed and received by the client 200 according to step 520. However, if the class of service is not upgraded by the user, in the next step 535 the client 200 is denied access to the resource.

Process and function descriptions and blocks in flow charts can be understood as representing, in some embodiments, modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention. In addition, such functional elements can be implemented as logic embodied in hardware, software, firmware, or a combination thereof, among others. In some embodiments involving software implementations, such software comprises an ordered listing of executable instructions for implementing logical functions and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a computer-readable medium can be any means that can contain, store, communicate, propagate, or transport the software for use by or in connection with the instruction execution system, apparatus, or device.

It should be emphasized that the above-described embodiments of the present invention are merely possible examples of implementations set forth for a clear understanding of the principles of the invention. Many variations and modifications may be made to the above-described embodiment(s) of the invention without departing substantially from the principles of the invention. All such modifications and variations are intended to be included herein within the scope of this disclosure and the present invention and protected by the following claims.

What is claimed is:

1. A network resource management system, comprising:
a server on a network operable to provide a remote terminal coupled to the network with a class of service marker specific to a user of the remote terminal, and a roster list comprising a plurality of resources present on the network;
the server being further operable to receive a routing request from the remote terminal, the routing request comprising a request for at least one resource from said roster list and the class of service marker; and
the server being further operable to check the class of service marker of the remote terminal to verify authorization before permitting access to said resource by said user.

2. The system of claim 1, wherein the resource is operable to check the server for the class of service marker corresponding to the user.

3. The system of claim 2, wherein routing to the resource is denied if the policy does not permit access to the resource by the class of service marker received from the remote terminal.

4. The system of claim 3, wherein routing to the resource is denied if the permanent database includes a different class of service marker than has been provided by the user.

5. The system of claim 3, wherein routing to the resource is denied if said at least one resource is not included within the roster list of the user.

6. The system of claim 1, wherein the resource is a software application residing on an application server.

7. The system of claim 1, wherein the resource is another user, and requesting the resource allows the user to attempt to chat with the other user.

8. The system of claim 1, wherein the network comprises a plurality of network connection sockets, the plurality of network connection sockets having at least two subgroups having different data rate connections, and the requested resource is a network connection socket in a particular subgroup.

9. The system of claim 1, wherein the server comprises:
a class of service database coupled to an authentication database, the server being operable to provide a class of service marker to a remote terminal associated with a particular user after authenticating the particular user with the authentication database.

10. The system of claim 9, wherein the server further comprises:
a service manager operable to send a resource list comprising a plurality of resources to the remote terminal.

11. The system of claim 10, wherein the service manager is further operable to send the resource list to the remote terminal and indicate a presence status of each of the plurality of resources with respect to the user, and the presence status of the resource indicates whether a resource is on-line or off-line.

12. The system of claim 11, wherein the service manager is further operable to indicate an availability status of each of the plurality of resources with respect to the user, and the availability status is determined based upon a class of service permission to use a resource.

13. The system of claim 10, wherein the service manager is further operable to send the resource list to the remote terminal and indicate an availability status for each of the plurality of resources on the resource list, and the availability status is determined based upon a class of service permission to use a resource.

14. The system of claim 10, further comprising:
a service router operable to receive the routing request for a resource, check the class of service marker associated with the routing request against the policy, and route the resource if the policy allows the resource to be routed to the user.

15. The system of claim 14, wherein the service router comprises a JabberD service router, and the service manager comprises a Jabber Service Manager.

16. The system of claim 1, wherein a class of service marker corresponding to the user can be adjusted by a database administrator to provide a different level of access to the plurality of resources.

17. The system of claim 16, wherein the database administrator can set the class of service marker to allow access to the plurality of resources based upon at least one circumstance.

18. The system of claim 17, wherein said at least one circumstance comprises a time period during which access is allowed.

19. The system of claim 18, wherein said at least one circumstance comprises allowing access only during business hours.

20. The system of claim 17, wherein said at least one circumstance comprises allowing access only from a particular network address associated with the user on the network.

21. The system of claim 1, wherein the class of service marker comprises an encoded security string, and the system is operable to decode and check the security string upon receiving the routing request.

22. The system of claim 1, wherein a network administrator can invoke a change of presence with respect to at least one class of service level.

23. A class of service system, comprising:
a remote terminal associated with a user, the remote terminal being operable to register with a server and receive a class of service marker and to request and receive a roster list, the roster list comprising a plurality of resources that are present on the network;
the remote terminal being further operable to send a routing request to a service router, the routing request including the class of service marker and a request for routing to a resource; and
the remote terminal being further operable to receive the resource if the class of service marker allows routing of the resource.

24. The system of claim 23, wherein the roster list further comprises a plurality of resources that are present and available on the network.

25. The system of claim 24, wherein the roster list delineates between which of the plurality of resources on the roster list are merely present, and which resources on the roster list are available.

26. The system of claim 24, wherein the roster list includes the plurality of resources which are both residing on a server that is present and available on the network, and to which the service router allows routing, according to the class of service marker corresponding to the user.

27. The system of claim 23, wherein the remote terminal is operable to use a modified Jabber client to communicate with the server.

28. The system of claim 23, wherein the remote terminal is operable to use a modified Jabber client to request the class of service marker from the server, to request the roster list, and to send the routing request.

29. The system of claim 28, wherein the modified Jabber client comprises an operating system for the remote terminal, operable to generate a display comprising a plurality of resources for display to the user.

30. The system of claim 23, wherein at least one of the plurality of resources is a person, and choosing that resource causes a chat invitation to be sent to the person.

31. The system of claim 23, wherein the resource is an application residing on an application server coupled to the network.

32. The system of claim 23, wherein the resource is a network connection socket among a plurality of network connection sockets, the plurality of network connection sockets having at least two connection datarates.

33. The system of claim 23, wherein registration comprises providing a user authentication and an internet protocol address.

34. A method for managing access to network resources, comprising:
receiving a registration request over a network from a user of a remote terminal;
searching a database to find a class of service marker associated with the user;
sending the class of service marker to the remote terminal; and
sending a roster list comprising a plurality of resources which are present.

35. The method of claim 34, further comprising:
sending the roster list to the user via the network, the roster list comprising a plurality of off-line resources which are marked as not-present because a server providing the resource is not coupled to the network.

36. The method of claim 35, further comprising:
sending a roster list to the user via the network, the roster list comprising a plurality of resources marked as not-present because the class of service marker corresponding to the user does not permit routing of the plurality of resources marked as not-present.

37. The method of claim 35, further comprising:
sending the roster list to the user via the network, the roster list comprising a plurality of unavailable resources, unavailable because the user does not have a class of service permission to use the plurality of unavailable resources.

38. The method of claim 34, further comprising:
receiving a resource request from the remote terminal, which includes the class of service marker, to deliver a requested resource to the remote terminal.

39. The method of claim 38, further comprising:
checking a security layer to assure that the requested resource is present and available to the class of service marker received from the remote terminal.

40. The method of claim 39, wherein checking a security layer comprises:
checking the class of service marker received from the user against a class of service marker stored in the database.

41. The method of claim 39, wherein checking a security layer comprises:
checking a security string associated with the class of service marker to authenticate the class of service marker received.

42. The method of claim 39, further comprising:
routing the requested resource to the remote terminal when the requested resource is present and available to the class of service marker received from the remote terminal.

43. The method of claim 42, further comprising:
checking the class of service marker received from the remote terminal against the class of service marker associated with the user by the database to ensure that the user has not altered the class of service marker.

44. The method of claim 34, further comprising:
receiving a request from the remote terminal, which includes the class of service marker, to deliver a requested resource to the remote terminal;
checking a security layer to assure that the requested resource is present and available to the class of service marker received from the remote terminal;
routing the requested resource to the remote terminal the requested resource is present and available to the class of service marker received from the remote terminal; and
checking the class of service marker received from the remote terminal against the class of service marker associated with the user by the database to ensure that the user has not altered the class of service marker.

45. The method of claim 44, further comprising:
providing a connection to a resource that corresponds to chatting with another user when the class of service marker indicates that the connection is permitted.

46. The method of claim 44, further comprising:
providing a connection to a resource that corresponds to a software application when the class of service marker indicates that the connection is permitted.

47. The method of claim 44, further comprising:
providing a connection to a resource that corresponds to a network connection socket of a particular bandwidth when the class of service marker indicates that the connection is permitted.

48. The method of claim 34, further comprising:
using a Jabber Service Manager check the class of service marker and to provide the roster list to the remote terminal.

49. The method of claim 34, further comprising:
using a Jabber D service router to check the class of service marker and route the resource to the remote terminal.

50. The method of claim 34, further comprising:
receiving a resource request, including the class of service marker; and
checking a security layer definition against the class of service marker for authorization to access the requested resource.

51. The method of claim 50, further comprising;
refusing access when the user is requesting a resource outside of a time window included in the security layer definition allowing access to the class of service marker.

52. The method of claim 50, further comprising;
refusing access when the user is requesting a resource from a terminal not included in the security layer definition allowing access to the class of service marker.

53. A method for requesting use of a resource, the method comprising:
registering with a server residing on a network;
receiving a class of service marker and a roster list corresponding to a plurality of resources which are present on the network;
requesting a resource from the roster list; and
including the class of service marker with the resource request.

54. The method of claim 53, further comprising:
receiving the resource if the class of service marker allows routing of the resource.

55. The method of claim 53, further comprising:
receiving a roster list comprising a plurality of resources which are present and available on the network.

56. The method of claim 55, further comprising:
receiving a roster list which details which of the plurality of resources on the roster list are merely present, and which of the plurality of resources are available.

57. The method of claim 55, further comprising:
receiving a roster list detailing which of the plurality of resources are both residing on a server that is present and available on the network, and to which a service router allows routing, according to the class of service marker corresponding to the user.

58. The method of claim 53, further comprising:
using a modified Jabber client to communicate with the server.

59. The method of claim 53, further comprising:
using a modified Jabber client to register with the server, to receive the class of service marker from the server with the roster list, and to send the resource request to the server.

60. The method of claim 59, further comprising:
using the modified Jabber client as an operating system for the remote terminal and to generate a display comprising the roster list;

61. The method of claim 53, further comprising:
requesting a resource that corresponds to a person with whom the user would like to chat.

62. The method of claim 53, further comprising:
requesting a resource that corresponds to an application residing on an application server coupled to the network.

63. The method of claim 53, further comprising:
requesting a resource that corresponds to a particular network connection socket among a plurality of network connection sockets having at least two connection datarates.

64. The method of claim 53, further comprising:
providing authentication of the user prior to receiving a class of service marker from the server.
